(19) United States
(12) Patent Application Publication
(10) Pub. No.: US 2023/0339117 A1
(43) Pub. Date: Oct. 26, 2023

(54) DEVICE FOR OBTAINING POSITION OF VISUAL SENSOR IN CONTROL COORDINATE SYSTEM OF ROBOT, ROBOT SYSTEM, METHOD, AND COMPUTER PROGRAM

(71) Applicant: FANUC CORPORATION, Yamanashi (JP)

(72) Inventor: Kyouhei KOKUBO, Yamanashi (JP)

(21) Appl. No.: 17/918,326

(22) PCT Filed: Apr. 6, 2021
(86) PCT No.: PCT/JP2021/014676

§ 371 Date: Oct. 12, 2022

(30) Foreign Application Priority Data
Apr. 13, 2020 (JP) 2020-071864

(51) Int. Cl. B25J 9/16

(52) U.S. Cl. CPC B25J 9/1697; B25J 9/1692; B25J 9/1653; B25J 9/1607

(57) ABSTRACT

A processor of a device, for obtaining the position of a visual sensor in a control coordinate system: causes a robot to operate to change the attitude of the visual sensor or a marker by a first amount of change in attitude; obtains the position of the visual sensor in the control coordinate system as a trial measurement position on the basis of image data of the marker captured by the visual sensor before and after the change in the attitude; causes the robot to operate to change the attitude by a second amount of change in attitude that is greater than the first amount of change in attitude; and obtains the position of the visual sensor in the control coordinate system as an actual measurement position on the basis of image data of the marker captured by the visual sensor before and after the change in attitude.

### TECHNICAL FIELD

The present invention relates to a device, a robot system, a method, and a computer program for acquiring a position of a vision sensor in a control coordinate system of a robot.

### BACKGROUND ART

In the related art, a device configured to measure a position and an orientation of a vision sensor in a control coordinate system of a robot based on image data obtained by imaging an index mark with the vision sensor is known (e.g., Patent Literature (PTL) 1 and PTL 2).

### CITATION LIST

### Patent Literature

PTL 1: JP 2005-201824 A
PTL 2: JP 2005-300230 A

### SUMMARY OF INVENTION

### Technical Problem

In the related art, in order to measure a position of a vision sensor in a control coordinate system, it is necessary to change a relative orientation of the vision sensor with respect to an index mark (e.g., rotate the vision sensor or the index mark about a predetermined axis). In this case, the index mark may be out of the field of view of the vision sensor.

### Solution to Problem

In an aspect of the present disclosure, a device configured to acquire a position of a vision sensor in a control coordinate system for controlling a robot configured to relatively move the vision sensor and an index mark includes a processor. The processor configured to operate the robot so as to change an orientation of the vision sensor or the index mark by a first orientation change amount; acquire, as a trial measurement position, a position of the vision sensor in the control coordinate system based on image data of the index mark imaged by the vision sensor before and after the orientation is changed by the first orientation change amount; operate the robot so as to change the orientation by a second orientation change amount larger than the first orientation change amount in an orientation change direction which is determined based on the trial measurement position; and acquires, as a real measurement position, a position of the vision sensor in the control coordinate system based on image data of the index mark imaged by the vision sensor before and after the orientation is changed by the second orientation change amount.

In an aspect of the present disclosure, a method of acquiring a position of a vision sensor in a control coordinate system for controlling a robot configured to relatively move the vision sensor and an index mark includes, by a processor, operating the robot so as to change an orientation of the vision sensor or the index mark by a first orientation change amount; acquiring, as a trial measurement position, a position of the vision sensor in the control coordinate system based on image data of the index mark imaged by the vision sensor before and after the orientation is changed by the first orientation change amount, operating the robot so as to change the orientation by a second orientation change amount larger than the first orientation change amount in an orientation change direction which is determined based on the trial measurement position; and acquiring, as a real measurement position, a position of the vision sensor in the control coordinate system based on image data of the index mark imaged by the vision sensor before and after the orientation is changed by the second orientation change amount.

### Advantageous Effects of Invention

According to the present disclosure, by changing the orientation of the vision sensor by a relatively small orientation change amount, a trial measurement position of the vision sensor in the control coordinate system is approximated, and then the orientation of the vision sensor is changed by a larger orientation change amount, thereby determining a real measurement position of the vision sensor in the control coordinate system. According to this configuration, a real measurement position indicating an exact position of the vision sensor in the control coordinate system may be acquired while preventing the index mark from being out of the field of view of the vision sensor after the change of the orientation.

### BRIEF DESCRIPTION OF DRAWINGS

FIG. 1 is a diagram of a robot system according to an embodiment.

FIG. 2 is a block diagram of the robot system illustrated in FIG. 2.

FIG. 3 illustrates an example of an index mark.

FIG. 4 is a flowchart illustrating an example of a method for acquiring a position of a vision sensor in a control coordinate system.

FIG. 5 is a flowchart illustrating an example of step S1 in FIG. 4.

FIG. 6 illustrates an example of image data of an index mark imaged by a vision sensor.

FIG. 7 is a flowchart illustrating an example of step S2 in FIG. 4.

FIG. 8 is a flowchart illustrating an example of step S3 in FIG. 4.

FIG. 9 is a diagram of a robot system according to another embodiment.

FIG. 10 illustrates an index mark provided in a robot illustrated in FIG. 9.

### DESCRIPTION OF EMBODIMENTS

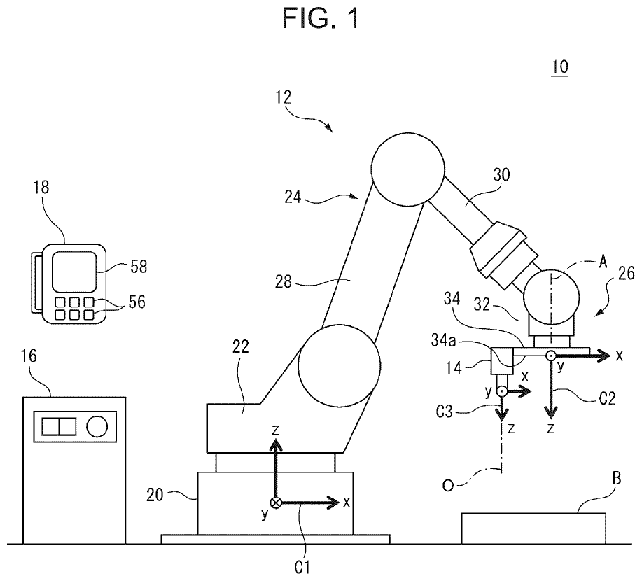

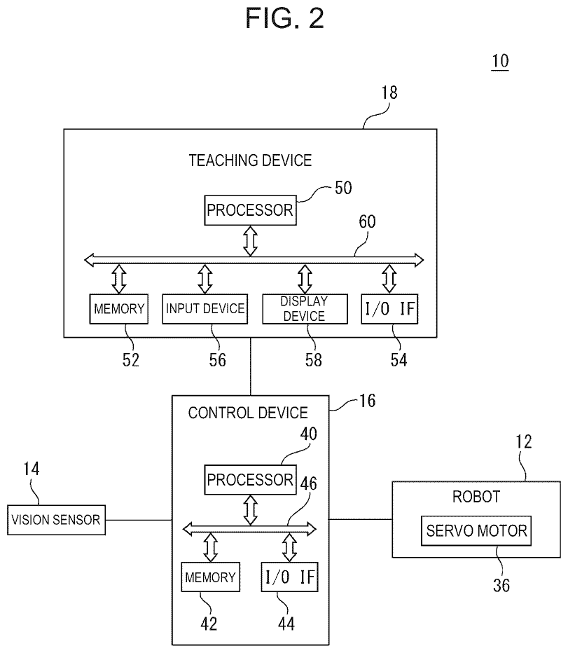

Hereinafter, embodiments of the present disclosure will be described in detail with reference to the drawings. Note that in various embodiments described below, the same elements are denoted by the same reference signs, and redundant description will be omitted. First, a robot system 10 according to an embodiment will be described with reference to FIG. 1 and FIG. 2. The robot system 10 includes a robot 12, a vision sensor 14, a control device 16, and a teaching device 18.

In the present embodiment, the robot 12 is a vertical articulated robot, and includes a robot base 20, a rotating torso 22, a robot arm 24, and a wrist 26. The robot base 20 is fixed to the floor of a work cell. The rotating torso 22 is provided on the robot base 20 in such a manner as to be able to rotate about a vertical axis. The robot arm 24 includes a lower arm 28 rotatably provided on the rotating torso 22 about a horizontal axis, and an upper arm 30 rotatably provided to a tip of the lower arm 28.

The wrist 26 includes a wrist base 32 rotatably coupled to a tip of the upper arm 30, and a wrist flange 34 rotatably provided on the wrist base 32 about an axis line A. The wrist flange 34 is a cylindrical member taking the axis line A as a central axis, and includes an attachment surface 34a on a tip side thereof. The wrist 26 rotates the wrist flange 34 about the axis line A.

An end effector (not illustrated) for performing a task on a workpiece is detachably attached to the attachment surface 34a. The end effector is a robot hand, a welding gun, a laser machining head, a coating material applicator, or the like, and performs a predetermined task (workpiece handling, welding, laser machining, coating, or the like) on the workpiece.

A servo motor 36 (FIG. 2) is incorporated in each of the constituent elements (i.e., the robot base 20, rotating torso 22, robot arm 24, and wrist 26) of the robot 12. The servo motor 36 drives each of the movable elements (i.e., the rotating torso 22, robot arm 24, and wrist 26) of the robot 12 in response to a command from the control device 16.

A robot coordinate system C1 (FIG. 1) is set in the robot 12. The robot coordinate system C1 is a control coordinate system to control operations of the movable elements of the robot 12, and is fixed in a three-dimensional space. In the present embodiment, the robot coordinate system C1 is set with respect to the robot 12 such that the origin of the robot coordinate system C1 is arranged at the center of the robot base 20 and the z-axis of the robot coordinate system C1 coincides with a rotation axis of the rotating torso 22.

On the other hand, as illustrated in FIG. 1, a mechanical interface (hereinafter, abbreviated as “MIF”) coordinate system C2 is set at a hand tip (specifically, the wrist flange 34) of the robot 12. The MIF coordinate system C2 is a control coordinate system to control the position and orientation of the wrist flange 34 (or the end effector) in the robot coordinate system CL. In the present embodiment, the MIF coordinate system C2 is set at the hand tip of the robot 12 such that the origin thereof is arranged at the center of the attachment surface 34a of the wrist flange 34 and the z-axis thereof coincides with the axis line A.

At the time of moving the wrist flange 34 (end effector), a processor 40 sets the MIF coordinate system C2 to the robot coordinate system C1, and controls each of the servo motors 36 of the robot 12 to arrange the wrist flange 34 (end effector) in the position and orientation represented by the set MIF coordinate system C2. Thus, the processor 40 may determine the positioning of the wrist flange 34 (end effector) in any position and any orientation in the robot coordinate system C1.

The vision sensor 14 is, for example, a camera or a three-dimensional vision sensor, and includes an image sensor (a CCD, CMOS, or the like) that receives a subject image and performs photoelectric conversion on the received image, an optical lens (a condensing lens, focusing lens, or the like) that focuses the subject image onto the image sensor, and the like. The vision sensor 14 images an image of an object and transmits the imaged image data to the control device 16. In the present embodiment, the vision sensor 14 is fixed at a prescribed position with respect to the wrist flange 34.

A sensor coordinate system C3 is set in the vision sensor 14. The sensor coordinate system C3 is a coordinate system that defines coordinates of each pixel of the image data imaged by the vision sensor 14, where the origin thereof is arranged at the center of a light reception surface of the image sensor (or the optical lens) of the vision sensor 14, the x-axis and y-axis thereof are respectively arranged in parallel with the lateral direction and the longitudinal direction of the image sensor, and the z-axis thereof is set with respect to the vision sensor 14 to coincide with a visual line (or an optical axis) O of the vision sensor 14.

The control device 16 controls the operations of the robot 12 and the vision sensor 14. Specifically, the control device 16 is a computer having the processor 40, a memory 42, and an I/O interface 44. The processor 40 includes a CPU, a GPU, or the like, and is communicably connected to the memory 42 and the I/O interface 44 via a bus 46. The processor 40 sends a command to the robot 12 and the vision sensor 14 to control the operations of the robot 12 and the vision sensor 14, while communicating with the memory 42 and the I/O interface 44.

The memory 42 includes a RAM, a ROM, or the like, and stores therein various types of data temporarily or permanently. The I/O interface 44 has, for example, an Ethernet (registered trademark) port, a USB port, an optical fiber connector, or an HDMI (registered trademark) terminal, and exchanges data with an external device through wireless or wired communications under a command from the processor 40. The servo motor 36 and the vision sensor 14 are communicably connected to the I/O interface 44 by a wireless or wired communication scheme.

The teaching device 18 is, for example, a hand-held device (such as a teach pendant or a tablet terminal device) that is used to teach the robot 12 the operations to perform a predetermined task. Specifically, the teaching device 18 is a computer including a processor 50, a memory 52, an I/O interface 54, an input device 56, and a display device 58. The processor 50 includes a CPU, a GPU, or the like, and is communicably connected to the memory 52, the input device 56, the display device 58, and the I/O interface 54 via a bus 60.

The memory 52 includes a RAM, a ROM, or the like, and stores therein various types of data temporarily or permanently. The I/O interface 54 has, for example, an Ethernet (registered trademark) port, a USB port, an optical fiber connector, or an HDMI (registered trademark) terminal, and exchanges data with an external device through wireless or wired communications under a command from the processor 50. The I/O interface 54 is connected to the I/O interface 44 of the control device 16 by a wired or wireless communication scheme, and the control device 16 and the teaching device 18 may communicate with each other.

The input device 56 includes a push button, a switch, a keyboard, a touch panel, or the like, and receives an input operation of an operator to transmit the input information to the processor 50. The display device 58 includes an LCD, an organic EL display, or the like, and displays various types of information under a command from the processor 50. The operator performs jog operation on the robot 12 by operating the input device 56, thereby making it possible to teach the operations to the robot 12.

In the present embodiment, the positional relationship between the MIF coordinate system C2 and the sensor coordinate system C3 is not calibrated and is unknown. However, when the robot 12 is made to perform a task on the workpiece based on image data imaged by the vision sensor 14, it is necessary to know the position of the vision sensor 14 (i.e., the origin position of the sensor coordinate system C3) in the control coordinate system for controlling the robot 12 (i.e., the robot coordinate system C1, the MIF coordinate system C2), and the orientation thereof (i.e., each axial direction of the sensor coordinate system C3).

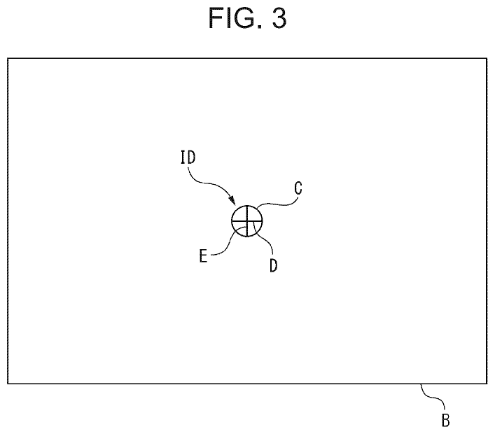

In the present embodiment, the teaching device 18 acquires data on the position and orientation of the vision sensor 14 in the control coordinate system (the robot coordinate system C1, the MIF coordinate system C2) based on the image data of an index mark ID imaged by the vision sensor 14. FIG. 3 illustrates an example of an index mark ID. In the present embodiment, the index mark ID is provided on the top surface of a structure B, and is constituted by a circle line C and two straight lines D and E orthogonal to each other. The index mark ID is provided on the structure B in a visually recognizable form such as a pattern using paint or a stamp mark (engraving) formed on the top surface of the structure B.

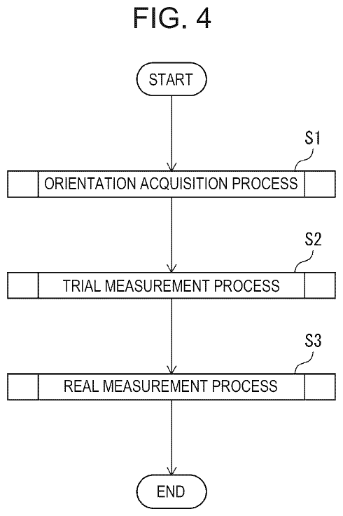

Next, with reference to FIG. 4, a method for acquiring the data on the position and orientation of the vision sensor 14 in the control coordinate system (the robot coordinate system C1, the MIF coordinate system C2) will be described. A flow illustrated in FIG. 4 starts when the processor 50 of the teaching device 18 receives an operation start command from an operator, a host controller, or a computer program CP. The processor 50 may carry out the flow illustrated in FIG. 4 in accordance with the computer program CP. The computer program CP may be stored in advance in the memory 52.

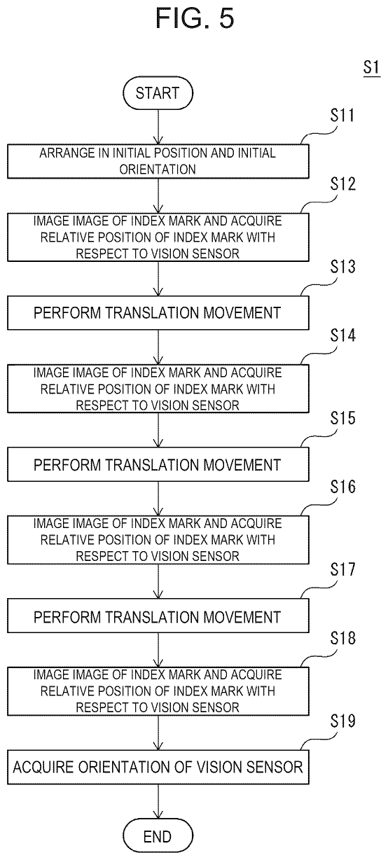

In step S1, the processor 50 executes an orientation acquisition process. The above-mentioned step S1 is described below with reference to FIG. 5. In step S1, the processor 50 operates the robot 12 to arrange the vision sensor 14 in an initial position PS₀ and an initial orientation OR₀ with respect to the index mark ID.

The initial position PS₀ and the initial orientation OR₀ are previously determined in such a manner that the index mark ID is set within the field of view of the vision sensor 14 when the vision sensor 14 is arranged in the initial position PS₀ and the initial orientation OR₀. The data on the initial position PS₀ and the initial orientation OR₀ (i.e., the data indicating the coordinates of the origin of the MIF coordinate system C2 and the direction of each axis thereof in the robot coordinate system C1) is previously defined in the computer program CP and stored in the memory 52.

In step S12, the processor 50 operates the vision sensor 14 to image an image of the index mark ID and acquire a relative position of the index mark ID with respect to the vision sensor 14 at this time. Specifically, the processor 50 operates the vision sensor 14 arranged in the initial position PS₀ and the initial orientation OR₀ to acquire image data JD₀ of the index mark ID by the vision sensor 14.

The processor 50 acquires, via the control device 16, the image data JD₀ from the vision sensor 14, and stores the acquired data in the memory 52. The processor 50 may acquire the image data JD₀ directly from the vision sensor 14 without the control device 16 being interposed. In this case, the I/O interface 54 may be communicably connected with the vision sensor 14 by a wired or wireless communication scheme.

Subsequently, the processor 50 acquires data indicating a relative position of the index mark ID with respect to the vision sensor 14 when the image data JD₀ is imaged. In this case, from image data JDₙ imaged by the vision sensor 14 arranged in any position PSₙ and orientation ORₙ in which the index mark ID can be within the field of view, relative position data of the index mark ID with respect to the vision sensor 14 when the above image data JDₙ, is imaged may be determined. The method thereof is described below.

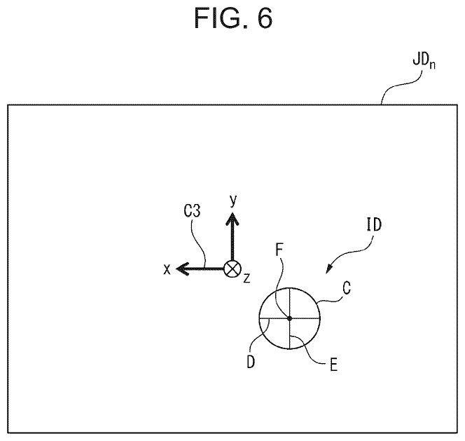

FIG. 6 illustrates an example of the image data JDₙ imaged by the vision sensor 14 arranged in any position PSₙ and orientation ORₙ. As illustrated in FIG. 6, in the present embodiment, the origin of the sensor coordinate system C3 is arranged at the center of the image data JDₙ (specifically, on a pixel present at the center). However, the origin of the sensor coordinate system C3 may be arranged in any known position (pixel) in the image data JDₙ.

The processor 50 analyzes the image data JDₙ and identifies an intersection point F of the straight lines D and E of the index mark ID shown in the image data JDₙ. Then, the processor 50 acquires coordinates (xₙ, yₙ) of the intersection point F in the sensor coordinate system C3 as data indicating the position of the index mark ID in the image data JDₙ.

The processor 50 analyzes the image data JDₙ and identifies a circle C of the index mark ID shown in the image data JDₙ. The processor 50 acquires an area of the circle C (or the number of pixels contained in the image region of the circle C) in the sensor coordinate system C3 as data indicating a size ISₙ (unit [pixel]) of the index mark ID shown in the image data JDₙ.

Further, the processor 50 acquires a size RS (unit [mm]) of the index mark ID in a real space, a focal distance FD of the optical lens of the vision sensor 14, and a size SS (unit [mm/pixel]) of the image sensor of the vision sensor 14. The size RS, the focal distance FD, and the size SS are stored in advance in the memory 52.

The processor 50 acquires a vector (Xₙ, Yₙ, Zₙ) by using the acquired coordinates (xₙ, yₙ), size ISₙ, size RS, focal distance FD, and size SS. In this case, Xₙ may be determined by an equation of Xₙ=xₙ×ISₙ×SS/RS, which is herein defined as Equation (1). Yₙ may be determined by an equation of Yₙ=Yₙ×ISₙ×SS/RS, which is herein defined as Equation (2). Zₙ may be determined by an equation of Zₙ=ISₙ×SS×FD/RS, which is herein defined as Equation (3).

The vector (Xₙ, Yₙ, Zₙ) is a vector from the vision sensor 14 when the image data JDₙ is imaged (i.e., the origin of the sensor coordinate system C3) to the index mark ID (specifically, the intersection point F), and is data indicating a relative position of the index mark ID with respect to the vision sensor 14 (or the coordinates of the sensor coordinate system C3).

As discussed above, the processor 50 acquires relative position data of the index mark ID (Xₙ, Yₙ, Zₙ) with respect to the vision sensor 14 when the image data JDₙ is imaged, based on the position of the index mark ID (xₙ, yₙ) in the image data JDₙ, the size ISₙ of the index mark ID shown in the image data JDₙ, the size RS of the index mark ID in the real space, the focal distance FD, and the size SS of the image sensor. In step S12, the processor 50 acquires relative position data of the index mark ID (X₀, Y₀, Z₀) with respect to the vision sensor 14 when the image data JD₀ is imaged.

In step S13, the processor 50 operates the robot 12 to make the vision sensor 14 perform translation movement. Here, a situation in which the robot 12 makes the hand tip perform “translation movement” refers to a situation in which the robot 12 moves the hand tip without changing the orientation of the hand tip. In the present embodiment, in a state in which the vision sensor 14 is arranged in the initial orientation OR₀, the processor 50 causes the vision sensor 14 to perform translation movement from the initial position PS₀ by a predetermined distance δx (e.g., δx=5 mm) in the x-axis direction of the MIF coordinate system C2 at this time point (i.e., the initial position PS₀ and the initial orientation OR₀) by the robot 12. As a result, the vision sensor 14 is arranged in a position PS₁ and the orientation OR₀ with respect to the index mark ID.

In step S14, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₁ of the index mark ID by the vision sensor 14 arranged in the position PS₁ and orientation OR₀, and acquires coordinates (x₁, y₁) of the intersection point F and a size IS₁ of the index mark ID shown in the image data JD₁.

The processor 50 acquires relative position data (X₁, Y₁, Z₁) of the index mark ID with respect to the vision sensor 14 when the image data JD₁ is imaged, by using the acquired coordinates (x₁, y₁) and size IS₁, and Equations (1) to (3) described above. Then, the processor 50 operates the robot 12 to return the vision sensor 14 into the initial position PS₀ and the initial orientation OR₀.

In step S15, the processor 50 operates the robot 12 to make the vision sensor 14 perform translation movement. Specifically, in the state in which the vision sensor 14 is arranged in the initial orientation OR₀, the processor 50 causes the vision sensor 14 to perform translation movement from the initial position PS₀ by a predetermined distance δy (e.g., δy=5 mm) in the y-axis direction of the MIF coordinate system C2 by the operation of the robot 12. As a result, the vision sensor 14 is arranged in a position PS₂ and the orientation OR₀ with respect to the index mark ID.

In step S16, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₂ of the index mark ID by the vision sensor 14 arranged in the position PS₂ and orientation OR₀, and acquires coordinates (x₂, y₂) of the intersection point F and a size IS₂ of the index mark ID shown in the image data JD₂.

The processor 50 acquires relative position data (X₂, Y₂, Z₂) of the index mark ID with respect to the vision sensor 14 when the image data JD₂ is imaged, by using the acquired coordinates (x₂, y₂) and size IS₂, and Equations (1) to (3) described above. Then, the processor 50 operates the robot 12 to return the vision sensor 14 to the initial position PS₀ and the initial orientation OR₀.

In step S17, the processor 50 operates the robot 12 to make the vision sensor 14 perform translation movement. Specifically, in the state in which the vision sensor 14 is arranged in the initial orientation OR₀, the processor 50 causes the vision sensor 14 to perform translation movement from the initial position PS₀ by a predetermined distance δz (e.g., δz=5 mm) in the z-axis direction of the MIF coordinate system C2 by the operation of the robot 12. As a result, the vision sensor 14 is arranged in a position PS₃ and the orientation OR₀ with respect to the index mark ID.

In step S18, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₃ of the index mark ID by the vision sensor 14 arranged in the position PS₃ and orientation OR₀, and acquires coordinates (x₃, y₃) of the intersection point F and a size IS₃ of the index mark ID shown in the image data JD₃.

The processor 50 acquires relative position data (X₃, Y₃, Z₃) of the index mark ID with respect to the vision sensor 14 when the image data JD₃ is imaged, by using the acquired coordinates (x₃, y₃) and size IS₃, and Equations (1) to (3) described above. Then, the processor 50 operates the robot 12 to return the vision sensor 14 to the initial position PS₀ and the initial orientation OR₀.

In step S19, the processor 50 acquires data indicating the orientation of the vision sensor 14 in the control coordinate system. Specifically, the processor 50 acquires a matrix M1 represented by a mathematical expression given below, by using the relative position data (Xₙ, Yₙ, Zₙ) (n=0, 1, 2, 3) acquired in steps S12, S14, S16, and S18.

$$[ Math . 1 ]$$

$$M 1 = ( \begin{matrix}( {X}_{1} - {X}_{0} ) / δ x & ( {X}_{2} - {X}_{0} ) / δ y & ( {X}_{3} - {X}_{0} ) / δ z \\ ( {Y}_{1} - {Y}_{0} ) / δ x & ( {Y}_{2} - {Y}_{0} ) / δ y & ( {Y}_{3} - {Y}_{0} ) / δ z \\ ( {Z}_{1} - {Z}_{0} ) / δ x & ( {Z}_{2} - {Z}_{0} ) / δ y & ( {Z}_{3} - {Z}_{0} ) / δ z\end{matrix} )$$

The matrix M1 is a rotation matrix representing an orientation (W, P, R) of the vision sensor 14 (or the sensor coordinate system C3) in the MIF coordinate system C2. The rotation matrix may be represented by three parameters of so-called roll, pitch, and yaw. Of the orientation (W, P, R), coordinates W correspond to a value of “yaw”, coordinates P correspond to a value of “pitch”, and coordinates R correspond to a value of “roll”. These orientation coordinates W, P, and R may be determined from the matrix M1.

In this manner, the processor 50 acquires the orientation data (W, P, R) of the vision sensor 14 in the MIF coordinate system C2, and stores the acquired data in the memory 52. The orientation data (W, P, R) defines the direction of each axis (i.e., the visual line O) of the sensor coordinate system C3 in the MIF coordinate system C2. Because the coordinates of the MIF coordinate system C2 and the coordinates of the robot coordinate system C1 are convertible to each other via a known conversion matrix, the orientation data (W, P, R) of the MIF coordinate system C2 may be converted to coordinates (W′, P′, R′) of the robot coordinate system C1.

The initial position PS₀ and the initial orientation OR₀, and the distances δx, δy, and δz described above are defined in such a manner that the index mark ID is set within the field of view of the vision sensor 14 in all positions and all orientations in which the vision sensor 14 is arranged in steps S11, S13, S15, and S17. For example, the operator defines the initial position PS₀ and the initial orientation OR₀ in such a manner that the visual line O of the vision sensor 14 passes through the inside of the circle C of the index mark ID.

The positional relationship between the index mark ID and the visual line O of the vision sensor 14 in the initial position PS₀ and initial orientation OR₀ may be estimated, for example, from design values of drawing data of the vision sensor 14, the robot 12, and the structure B (CAD data and the like). Thus, the index mark ID shown in the image data JD₀ may be arranged near the origin of the sensor coordinate system C3. The distances δx, δy, and δz may have different values from one another.

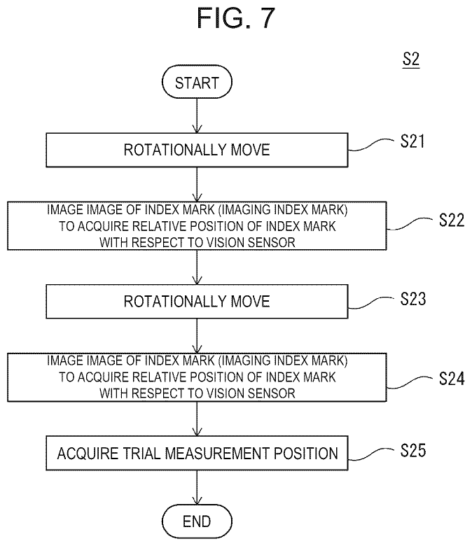

Referring to FIG. 4 again, in step S2, the processor 50 executes a trial measurement process. Hereinafter, step S2 is described with reference to FIG. 7. In step S21, the processor 50 rotationally moves the vision sensor 14, thereby changing the orientation of the vision sensor 14. Specifically, the processor 50 first sets a reference coordinate system C4 in the MIF coordinate system C2 at this time point (the initial position PS₀ and initial orientation OR₀).

In the present embodiment, the processor 50 sets the reference coordinate system C4 in the MIF coordinate system C2 in such a manner that the origin of the reference coordinate system C4 is arranged at the origin of the MIF coordinate system C2, and the orientation (the direction of each axis) thereof coincides with the orientation (W, P, R) acquired in step S19 described above. Accordingly, the directions of the x-axis, y-axis, and z-axis of the reference coordinate system C4 are parallel to those of the x-axis, y-axis, and z-axis of the sensor coordinate system C3, respectively.

Subsequently, the processor 50 operates the robot 12 to arrange the vision sensor 14 (i.e., the wrist flange) in a position PS₄ and an orientation OR₁ by rotating the vision sensor 14 by an orientation change amount θ₁ (first orientation change amount) about the z-axis (i.e., the axis parallel to the direction of the visual line O) of the reference coordinate system C4 from the initial position PS₀ and initial orientation OR₀. The orientation change amount θ₁ is defined as an angle in advance by the operator (e.g., θ₁=50), and is stored in the memory 52. In this manner, the processor 50 changes the orientation of the vision sensor 14 from the initial orientation OR₀ to the orientation OR₁.

In step S22, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₄ of the index mark ID by the vision sensor 14 arranged in the position PS₄ and orientation OR₁, and acquires coordinates (x₄, y₄) of the intersection point F and a size IS₄ of the index mark ID shown in the image data JD₄.

The processor 50 acquires relative position data (X₄. Y₄, Z₄) of the index mark ID with respect to the vision sensor 14 when the image data JD₄ is imaged, by using the acquired coordinates (x₄, y₄) and size IS₄, and Equations (1) to (3) described above. Then, the processor 50 operates the robot 12 to return the vision sensor 14 to the initial position PS₀ and the initial orientation OR₀.

In step S23, the processor 50 rotationally moves the vision sensor 14, thereby changing the orientation of the vision sensor 14. Specifically, the processor 50 operates the robot 12 to arrange the vision sensor 14 in a position PSs and an orientation OR₂ by rotating the vision sensor 14 by an orientation change amount θ₂ (first orientation change amount) about the x-axis or y-axis (i.e., the axis orthogonal to the direction of the visual line O) of the reference coordinate system C4 from the initial position PS₀ and initial orientation OR₀. The orientation change amount θ₂ is defined as an angle in advance by the operator (e.g., θ2=5°), and is stored in the memory 52. In this manner, the processor 50 changes the orientation of the vision sensor 14 from the initial orientation OR₀ to the orientation OR₂.

In step S24, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₅ of the index mark ID by the vision sensor 14 arranged in the position PS₅ and orientation OR₂, and acquires coordinates (x₅, y₅) of the intersection point F and a size IS₅ of the index mark ID shown in the image data JD₅.

The processor 50 acquires relative position data (X₅, Y₅, Z₅) of the index mark ID with respect to the vision sensor 14 when the image data JD₅ is imaged, by using the acquired coordinates (x₅, y₅) and size IS₅, and Equations (1) to (3) described above. Then, the processor 50 operates the robot 12 to return the vision sensor 14 to the initial position PS₀ and the initial orientation OR₀.

In step S25, the processor 50 acquires a trial measurement position of the vision sensor 14. In a case where a vector from the origin of the reference coordinate system C4 (the origin of the MIF coordinate system C2 in the present embodiment) in the MIF coordinate system C2 to the origin of the sensor coordinate system C3, the position of which is unknown, is represented as (ΔX₁, ΔY₁, ΔZ₁), Equations (4) and (5) given below hold.

$$[ Math . 2 ]$$

$$( \begin{matrix}cos {θ}_{1} & - sin {θ}_{1} \\ sin {θ}_{1} & cos {θ}_{1}\end{matrix} ) \cdot ( \begin{matrix}{X}_{0} + Δ {X}_{1} \\ {Y}_{0} + Δ {Y}_{1}\end{matrix} ) = ( \begin{matrix}{X}_{4} + Δ {X}_{1} \\ {Y}_{4} + Δ {Y}_{1}\end{matrix} ) \qquad Equation ( 4 )$$

$$[ Math . 3 ]$$

$$cos {θ}_{2} \cdot {Y}_{0} - sin {θ}_{2} \cdot ( {Z}_{0} + Δ {Z}_{1} ) = {Y}_{5} \qquad Equation ( 5 )$$

By solving Equations (4) and (5) described above, the processor 50 may estimate the vector (ΔX₁, ΔY₁, ΔZ₁) from the origin of the reference coordinate system C4 in the MIF coordinate system C2 to the origin of the sensor coordinate system C3, which is unknown. The vector (ΔX₁, ΔY₁, ΔZ₁) is data indicating an approximate position of the vision sensor 14 (the origin of the sensor coordinate system C3) in the MIF coordinate system C2. In step S25, the processor 50 acquires the trial measurement position as the coordinates (x_{T}, v_{T}, z_{T}) of the MIF coordinate system C2. In the present embodiment, x_{T} equals ΔX₁, y_{T} equals ΔY₁, and z_{T} equals ΔZ₁.

Of the trial measurement position (x_{T}, Y_{T}, z_{T}), a relation of (x_{T}, y_{T})=(ΔX₁, ΔY₁) is determined from Equation (4) described above by the operation of rotating the vision sensor 14 in a direction about the z-axis of the reference coordinate system C4 in step S21 discussed above. The trial measurement position (x_{T}, y_{T}) being equal to (ΔX₁, ΔY₁) indicates an approximate position of the visual line O in the MIF coordinate system C2 (in other words, an approximate position of the origin of the sensor coordinate system C3 in a plane orthogonal to the visual line O).

On the other hand, of the trial measurement position (x_{T}, y_{T}, z_{T}), z_{T}(=ΔZ₁) is determined from Equation (5) described above by the operation of rotating the vision sensor 14 in a direction about the x-axis or y-axis of the reference coordinate system C4 in step S23 discussed above. The trial measurement position Z_{T} (=ΔZ₁) indicates an approximate position of the vision sensor 14 (or the origin of the sensor coordinate system C3) in the MIF coordinate system C2 in a direction along the visual line O.

As described above, the processor 50 acquires the trial measurement position (x_{T}, y_{T}, z_{T}) based on the orientation change amounts θ₁ and θ₂, the relative position data (X₀, Y₀, Z₀) when the image data JD₀ is imaged before the change of the orientation (i.e., the initial orientation OR₀), and the relative position data (X₄, Y₄, Z₄) and (X₅, Y₅, Z₅) when the image data JD₄ and the image data JD₅ are respectively imaged after the change of the orientation (i.e., the orientation OR₁ and orientation OR₂). The processor 50 updates the coordinates in the MIF coordinate system C2 of the origin of the sensor coordinate system C3, which has been unknown, to the acquired trial measurement position (x_{T}, y_{T}, z_{T}), and stores the updated value in the memory 52.

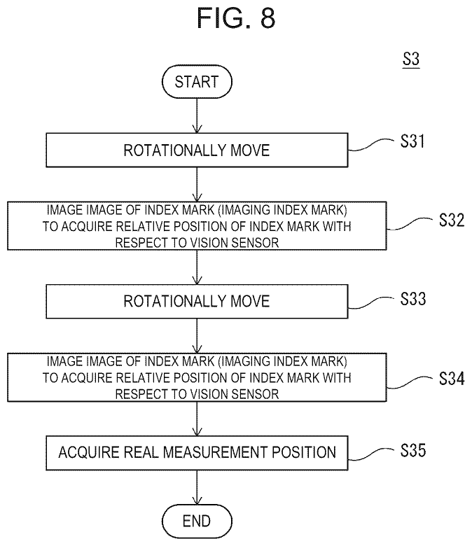

Referring again to FIG. 4, the processor 50 executes a real measurement process in step S3. Step S3 is described below with reference to FIG. 8. In step S31, the processor 50 rotationally moves the vision sensor 14, thereby changing the orientation of the vision sensor 14.

Specifically, the processor 50 first defines a direction DR₁ (orientation change direction), in which the vision sensor 14 is moved in order to change the orientation of the vision sensor 14 in step S31, as a direction about the z-axis of the sensor coordinate system C3, the origin position of which has been updated in step S25. The origin position of the sensor coordinate system C3 in the MIF coordinate system C2 at this time point is the trial measurement position (x_{T}, y_{T}, z_{T}), and therefore the z-axis of the sensor coordinate system C3 is an axis arranged at the trial measurement position (x_{T}, y_{T}, z_{T}) and parallel to the direction of the visual line O. In this way, the processor 50 defines the orientation change direction DR₁ based on the trial measurement position (x_{T}, y_{T}, z_{T}).

Subsequently, the processor 50 operates the robot 12 to arrange the vision sensor 14 in a position PS₆ and an orientation OR₃ by rotating the vision sensor 14 by an orientation change amount θ₃ (second orientation change amount) in the orientation change direction DR₁ (the direction about the z-axis of the sensor coordinate system C3) from the initial position PS₀ and initial orientation OR₀. The orientation change amount θ₃ is defined in advance (e.g., θ3=180°) by the operator as an angle greater than the above-described orientation change amount θ₁ (θ₃>θ₁), and is stored in the memory 52.

In step S32, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₆ of the index mark ID by the vision sensor 14 arranged in the position PS₆ and orientation OR₃, and acquires coordinates (x₆, y₆) of the intersection point F and a size IS₆ of the index mark ID shown in the image data JD₆.

The processor 50 acquires relative position data (X₆, Y₆, Z₆) of the index mark ID with respect to the vision sensor 14 when the image data JD₆ is imaged, by using the acquired coordinates (x₆, y₆) and size IS₆, and Equations (1) to (3) described above. Then, the processor 50 operates the robot 12 to return the vision sensor 14 to the initial position PS₀ and the initial orientation OR₀.

In step S33, the processor 50 rotationally moves the vision sensor 14, thereby changing the orientation of the vision sensor 14. Specifically, the processor 50 first defines an orientation reference position RP by using the trial measurement position (x_{T}, y_{T}, z_{T}) and the relative position data (X₀, Y₀, Z₀) acquired in step S12 described above.

More specifically, in the MIF coordinate system C2 having been set in the above-described step S1 (i.e., the initial position PS₀ and the initial orientation OR₀), the processor 50 defines the orientation reference position RP at a position separated from the trial measurement position (x_{T}, y_{T}, z_{T}) of the origin of the sensor coordinate system C3 by the vector (X₀. Y₀, Z₀) (i.e., at a position of the coordinates (x_{T}+X₀, y_{T}+Y₀, Z_{T}+Z₀) of the MIF coordinate system C2).

In a case where the orientation reference position RP is defined as described above, a relative position of the orientation reference position RP with respect to the trial measurement position (x_{T}, y_{T}, z_{T}) in the MIF coordinate system C2 of the initial position PS₀ and initial orientation OR₀ is the same as the relative position (X₀, Y₀, Z₀) of the index mark ID with respect to the vision sensor 14 when the image data JD₀ is imaged in step S12. In this manner, by defining the orientation reference position RP with reference to the trial measurement position (x_{T}, y_{T}, z_{T}), the orientation reference position RP can be arranged near an intersection point G of the index mark ID.

Subsequently, the processor 50 sets a reference coordinate system C5 in the MIF coordinate system C2 at this time point (i.e., the initial position PS₀ and initial orientation OR₀). To be specific, the processor 50 sets the reference coordinate system C5 in the MIF coordinate system C2 in such a manner that the origin of the reference coordinate system C5 is arranged in the orientation reference position RP and the orientation (the direction of each axis) thereof coincides with the orientation (W, P, R) acquired in step S19 described above. Thus, the directions of the x-axis, y-axis, and z-axis of the reference coordinate system C5 are parallel to those of the x-axis, y-axis, and z-axis of the sensor coordinate system C3, respectively.

Subsequently, the processor 50 defines a direction DR₂ (orientation change direction), in which the vision sensor 14 is moved in order to change the orientation of the vision sensor 14 in step S33, as a direction about the x-axis or y-axis of the reference coordinate system C5. The x-axis or y-axis of the reference coordinate system C5 is an axis arranged in the orientation reference position RP and orthogonal to the direction of the visual line O. As described above, the processor 50 defines the orientation reference position RP based on the trial measurement position (x_{T}, y_{T}, z_{T}), and defines the orientation change direction DR₂ with reference to the reference coordinate system C5 set in the reference position RP.

Subsequently, the processor 50 operates the robot 12 to arrange the vision sensor 14 in a position PS₇ and an orientation OR₄ by rotating the vision sensor 14 by an orientation change amount θ₄ (second orientation change amount) in the orientation change direction DR₂ (the direction about the x-axis or y-axis of the reference coordinate system C5) from the initial position PS₀ and initial orientation OR₀. The orientation change amount θ₄ is defined in advance (e.g., θ₄=30°) by the operator as an angle greater than the above-described orientation change amount θ₂ (θ₄>θ₂), and is stored in the memory 52.

In step S34, as in the above-described step S12, the processor 50 operates the vision sensor 14 to image an image of the index mark ID and acquire a relative position of the index mark ID with respect to the vision sensor 14 at this time. Specifically, the processor 50 acquires image data JD₇ of the index mark ID by the vision sensor 14 arranged in the position PS₇ and orientation OR₄, and acquires coordinates (x₇, y₇) of the intersection point F and a size IS₇ of the index mark ID shown in the image data JD₇.

Then, the processor 50 acquires relative position data (X₇, Y₇, Z₇) of the index mark ID with respect to the vision sensor 14 when the image data JD₇ is imaged, by using the acquired coordinates (x₇, y₇) and size IS₇ and Equations (1) to (3) described above.

In step S35, the processor 50 acquires a real measurement position of the vision sensor 14 based on the relative position data (X₀, Y₀, Z₀), (X₆, Y₆, Z₆), and (X₇, Y₇, Z₇). In a case where a vector in a plane orthogonal to the z-axis of the sensor coordinate system C3 (i.e., the visual line O) from the trial measurement position (x_{T}, y_{T}, z_{T}) in the MIF coordinate system C2 having been acquired in step S25 to an exact origin position of the sensor coordinate system C3 is represented as (ΔX₂, ΔY₂), Equation (6) given below holds.

$$[ Math . 4 ]$$

$$( \begin{matrix}cos {θ}_{3} & - sin {θ}_{3} \\ sin {θ}_{3} & cos {θ}_{3}\end{matrix} ) \cdot ( \begin{matrix}{X}_{0} + Δ {X}_{2} \\ {Y}_{0} + Δ {Y}_{2}\end{matrix} ) = ( \begin{matrix}{X}_{6} + Δ {X}_{2} \\ {Y}_{6} + Δ {Y}_{2}\end{matrix} ) \qquad Equation ( 6 )$$

In a case where a vector in the direction of the z-axis of the sensor coordinate system C3 (i.e., the visual line O) from the orientation reference position RP (x_{T}+X₀, y_{T}+Y₀, z_{T}+Z₀) in the MIF coordinate system C2 (i.e., the origin position of the reference coordinate system C5 having been set in step S34) to the exact origin position of the sensor coordinate system C3 is represented as ΔZ₂, Equation (7) given below holds.

[Math. 5]

cos θ₄=Y₀−sin θ₄*(Z₀+ΔZ₂)=Y₇ Equation (7)

By solving Equations (6) and (7) described above, the processor 50 may determine the vector (ΔX₂, ΔY₂) and the vector ΔZ₂ in the MIF coordinate system C2. The vector (ΔX₂, ΔY₂) indicates an exact position of the visual line O in the MIF coordinate system C2 (in other words, a position of the origin of the sensor coordinate system C3 in a plane orthogonal to the visual line O). The vector ΔZ₂ indicates an exact position of the vision sensor 14 (or the origin of the sensor coordinate system C3) in the MIF coordinate system C2 in a direction along the visual line O.

From ΔX₂, ΔY₂, and ΔZ₂, the position of the origin of the sensor coordinate system C3 (x_{R}, y_{R}, z_{R}) in the MIF coordinate system C2 may be determined accurately as the real measurement position. As described above, in step S35, the processor 50 acquires the real measurement position (x_{R}, y_{R}, z_{R}) based on the orientation change amounts θ₃ and θ₄, the relative position data (X₀, Y₀, Z₀) when the image data JD₀ is imaged before the change of the orientation (i.e., the initial orientation OR₀), and the relative position data (X₆, Y₆, Z₆) and (X₇, Y₇, Z₇) when the image data JD₆ and the image data JD₇ are respectively imaged after the change of the orientation (i.e., the orientation OR₃ and orientation OR₄).

The processor 50 updates the coordinates of the origin of the sensor coordinate system C3 in the MIF coordinate system from the trial measurement position (x_{T}, y_{T}, z_{T}) having been approximated in step S25 to the real measurement position (x_{R}, y_{R}, z_{R}), and stores the updated value in the memory 52. The real measurement position (x_{R}, y_{R}, z_{R}) indicates the position of the vision sensor 14 (specifically, the coordinates of the origin of the sensor coordinate system C3) in the MIF coordinate system with high precision, and indicates the positional relationship between the MIF coordinate system C2 and the sensor coordinate system C3.

Thus, the sensor coordinate system C3 may be calibrated with respect to the control coordinate system (the robot coordinate system C1, the MIF coordinate system C2), and the control device 16 may recognize the position and the orientation of the vision sensor 14 in the control coordinate system. Accordingly, the control device 16 acquires the position of the workpiece in the robot coordinate system C1 based on the image data of the workpiece (not illustrated) imaged by the vision sensor 14, and may accurately perform the task on the workpiece with the end effector attached to the hand tip of the robot 12.

As described above, in the present embodiment, the processor 50 changes, in the trial measurement process of step S2, the orientation of the vision sensor 14 by the first orientation change amounts θ₁, θ₂ to approximate the trial measurement position (x_{T}, y_{T}, z_{T}) of the vision sensor 14 in the control coordinate system (MIF coordinate system C2), and changes, in the real measurement process of step S3, the orientation of the vision sensor 14 by the larger orientation change amounts θ₂, θ₄ to determine the real measurement position (x_{R}, y_{R}, z_{R}).

In a case where the position of the vision sensor 14 in the control coordinate system is to be determined by the first measurement without executing any of the trial measurement process and the real measurement process, the orientation of the vision sensor 14 needs to be changed by the large orientation change amounts θ₂, θ₄ in the first measurement process. This is because the measurement precision of the position of the vision sensor 14 in the control coordinate system is lowered unless the orientation of the vision sensor 14 is largely changed. However, in a case where the orientation of the vision sensor 14 is largely changed in the first measurement process, the index mark ID may be out of the field of view of the vision sensor 14 after the change of the orientation, and there arises a risk that the image of the index mark ID cannot be imaged.

In the present embodiment, the process for measuring the position of the vision sensor 14 in the control coordinate system is divided into the trial measurement process and the real measurement process, and in steps S21 and S23 of the trial measurement process, the orientation of the vision sensor 14 is changed by the relatively small first orientation change amounts θ₁, θ₂. As a result, the trial measurement position (x_{T}, y_{T}, z_{T}) of the vision sensor 14 may be approximated while preventing the index mark ID from being out of the field of view of the vision sensor 14 after the change of the orientation.

Then, in the real measurement process in step S3, the orientation of the vision sensor 14 is changed in steps S31 and S33 in the orientation change directions DR₁, DR₂ determined based on the trial measurement position (x_{T}, y_{T}, z_{T}) by the larger second orientation change amounts θ₃, θ₄. This configuration makes it possible to determine the exact position of the vision sensor 14 (x_{R}, y_{R}, z_{R}) in the control coordinate system (MIF coordinate system C2) while preventing the index mark ID from being out of the field of view of the vision sensor 14 after the change of the orientation.

Further, in the present embodiment, in step S33 described above, the processor 50 defines the orientation reference position RP based on the trial measurement position (x_{T}, Y_{T}, Z_{T}), and defines the direction about the x-axis or y-axis of the reference coordinate system C5 arranged in the orientation reference position RP as the orientation change direction DR₂. According to this configuration, the index mark ID can more effectively be prevented from being out of the field of view of the vision sensor 14 when step S33 is executed.

Furthermore, the processor 50 defines the orientation reference position RP in such a manner that a relative position of the orientation reference position RP with respect to the trial measurement position (x_{T}, Y_{T}, Z_{T}) coincides with the relative position of the index mark ID (X₀. Y₀, Z₀) with respect to the vision sensor 14 when the image data JD₀ is imaged. This configuration makes it possible to arrange the orientation reference position RP near the intersection point G of the index mark ID, so that the index mark ID can more effectively be prevented from being out of the field of view of the vision sensor 14 when step S33 is executed.

In the present embodiment, the processor 50 acquires the relative position data (Xₙ, Yₙ, Zₙ), and acquires the trial measurement position (x_{T}, y_{T}, z_{T}) and the real measurement position (x_{R}, y_{R}, z_{R}) based on the relative position data (Xₙ, Yₙ, Zₙ). According to this configuration, the position of the vision sensor 14 (the trial measurement position, the real measurement position) in the control coordinate system can be acquired without executing a process for positioning the position of the index mark ID (intersection point F) in the image data JDₙ imaged by the vision sensor 14 (the coordinates of the sensor coordinate system C3) at a prescribed position (e.g., the center). Accordingly, the task may be performed quickly.

In step S21 described above, the processor 50 may set the reference coordinate system C4 with respect to the robot coordinate system C1 in such a manner that the origin of the reference coordinate system C4 is arranged at the origin of the robot coordinate system C1. In this case as well, the processor 50 may determine the trial measurement position and the real measurement position by modifying Equations (4) to (7) described above in accordance with the origin position of the reference coordinate system C4.

In the embodiment described above, the robot coordinate system C1 and the interface coordinate system C2 are exemplified as the control coordinate system. However, other coordinate systems such as a world coordinate system C6, a workpiece coordinate system C7, and a user coordinate system C8 may be set as the control coordinate system. The world coordinate system C6 is a coordinate system that defines a three-dimensional space of a work cell where the robot 12 performs a task, and is fixed to the robot coordinate system C1. The workpiece coordinate system C7 is a coordinate system that defines a position and an orientation of a workpiece on which the robot 12 performs a task in the robot coordinate system C1 (or the world coordinate system C7).

The user coordinate system C8 is a coordinate system that is optionally set by the operator in order to control the robot 12. For example, the operator may set the user coordinate system C8 to a known position and a known orientation of the MIF coordinate system C2. In other words, the origin of the user coordinate system C8 in this case is arranged at known coordinates (x_{c}, y_{c}, z_{c}) in the MIF coordinate system C2.

As an example, the user coordinate system C8 is set with respect to the MIF coordinate system C2 in such a manner that the origin of the user coordinate system C8 is located at the center of the light reception surface (or the optical lens) of the image sensor of the vision sensor 14 relative to the origin of the MIF coordinate system C2, i.e., located near the position where the origin of the sensor coordinate system C3 is to be arranged.

The position of the center of the light reception surface (or the optical lens) of the image sensor of the vision sensor 14 with respect to the center of the attachment surface 34a, at which the origin of the MIF coordinate system C2 is arranged, may be estimated from the information such as the specifications of the vision sensor 14 and the attachment position of the vision sensor 14 with respect to the robot 12 (the wrist flange 34). Alternatively, the operator may acquire the design value of the position of the center of the light reception surface of the image sensor of the vision sensor 14 with respect to the center of the attachment surface 34a from the drawing data (such as CAD data) of the vision sensor 14 and the robot 12, for example.

With reference to the above-mentioned estimation value or design value, the operator sets the coordinates (x_{c}, y_{c}, z_{c}) of the user coordinate system C8 in advance in such a manner as to arrange the origin of the user coordinate system C8 at the center of the light reception surface (or the optical lens) of the image sensor of the vision sensor 14. In this case, in step S21 discussed above, the processor 50 may set the reference coordinate system C4 in the MIF coordinate system C2 in such a manner that the origin of the reference coordinate system C4 is arranged at the origin of the user coordinate system C8 (x_{c}, y_{c}, z_{c}), and the orientation (the direction of each axis) thereof coincides with the orientation (W, P, R) acquired in step S19.

The processor 50 may cause the vision sensor 14 to rotate about the z-axis of the reference coordinate system C4 by the operation of the robot 12. Further, the processor 50 may cause the vision sensor 14 to rotate about the x-axis or v-axis of the reference coordinate system C4 in step S23. This configuration makes it possible to arrange the origin of the reference coordinate system C4 at a position near the exact position (x_{R}, y_{R}, Z_{R}) of the origin of the sensor coordinate system C3, so that the index mark ID can be effectively prevented from being out of the field of view of the vision sensor 14 in steps S21 and S23.

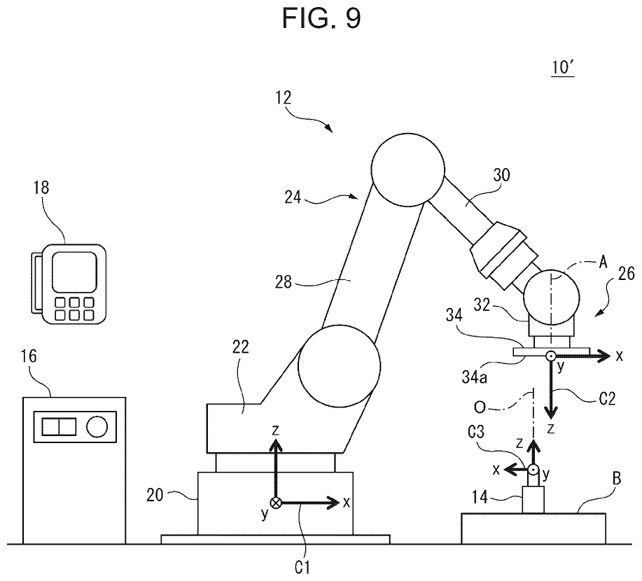

In the above-described embodiment, the case in which the robot 12 moves the vision sensor 14 is described. However, the robot 12 may move the index mark ID relative to the vision sensor 14. Such an embodiment is illustrated in FIG. 9. A robot system 10′ illustrated in FIG. 9 differs from the above-discussed robot system 10 in the arrangement of the vision sensor 14 and the index mark ID.

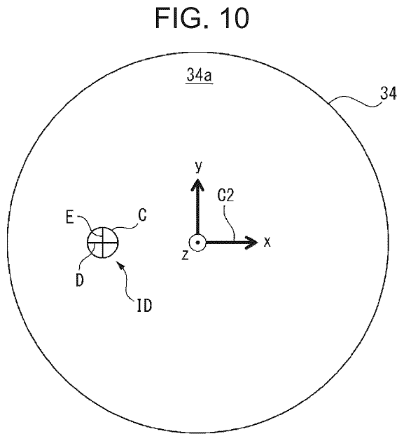

Specifically, in the robot system 10′, while the vision sensor 14 is fixedly provided on the upper surface of the structure B, the index mark ID is provided on the attachment surface 34a of the wrist flange 34 of the robot 12 as illustrated in FIG. 10. In the robot system 10′ as well, the processor 50 of the teaching device 18 may acquire the position of the vision sensor 14 in the control coordinate system by carrying out the flows depicted in FIGS. 4, 5, 7, and 8.

Hereinafter, the operations of the robot system 10′ will be described. Referring to FIG. 5, in step S11, the processor 50 operates the robot 12 to arrange the index mark ID (i.e., the wrist flange 34) in an initial position PS₀ and an initial orientation OR₀ with respect to the vision sensor 14. At this time, the index mark ID is set within the field of view of the vision sensor 14. In step S12, the processor 50 acquires image data JD₀ by imaging an image of the index mark ID with the vision sensor 14, and acquires relative position data of the index mark ID (X₀, Y₀, Z₀) with respect to the vision sensor 14.

In step S13, the processor 50 makes the index mark ID perform translation movement by a predetermined distance δx from the initial position PS₀ and initial orientation OR₀ in the x-axis direction of the robot coordinate system C1. In step S14, the processor 50 acquires image data JD₁ by imaging an image of the index mark ID with the vision sensor 14, and acquires relative position data of the index mark ID (X₁, Y₁, Z₁) with respect to the vision sensor 14.

In step S15, the processor 50 makes the index mark ID perform translation movement by a predetermined distance δy from the initial position PS₀ and initial orientation OR₀ in the y-axis direction of the robot coordinate system C1. In step S16, the processor 50 acquires image data JD₂ by imaging an image of the index mark ID with the vision sensor 14, and acquires relative position data of the index mark ID (X₂, Y₂, Z₂) with respect to the vision sensor 14.

In step S17, the processor 50 makes the index mark ID perform translation movement by a predetermined distance δz from the initial position PS₀ and initial orientation OR₀ in the z-axis direction of the robot coordinate system C1. In step S18, the processor 50 acquires image data JD₃ by imaging an image of the index mark ID with the vision sensor 14, and acquires relative position data of the index mark ID (X₃, Y₃, Z₃) with respect to the vision sensor 14. In step S19, the processor 50 determines a matrix M1 by using the relative position data (Xₙ, Yₙ, Zₙ) (n=0, 1, 2, 3), and acquires orientation data (W, P, R) of the vision sensor 14 from the matrix M1.

Referring to FIG. 7, in step S21, the processor 50 rotationally moves the index mark ID, thereby changing the orientation of the index mark ID. Specifically, in the MIF coordinate system C2 at this time point (the initial position PS₀ and initial orientation OR₀), the processor 50 first sets the reference coordinate system C4 in such a manner that the origin of the reference coordinate system C4 is arranged at the origin of the MIF coordinate system C2, and the orientation (the direction of each axis) thereof coincides with the orientation (W, P, R) acquired in step S19. Subsequently, the processor 50 operates the robot 12 to rotate the index mark ID from the initial position PS₀ and initial orientation OR₀ by an orientation change amount θ₁ about the z-axis of the reference coordinate system C4 (i.e., the axis parallel to the direction of the visual line O).

In step S22, the processor 50 operates the vision sensor 14 to image an image of the index mark ID and acquire relative position data (X₄, Y₄, Z₄) of the index mark ID with respect to the vision sensor 14 at this time. In step S23, the processor 50 operates the robot 12 to rotate the index mark ID from the initial position PS₀ and the initial orientation OR₀ by an orientation change amount θ₂ about the x-axis or y-axis (i.e., the axis orthogonal to the direction of the visual line O) of the reference coordinate system C4.

In step S24, the processor 50 operates the vision sensor 14 to image an image of the index mark ID and acquire relative position data (X₅, Y₅, Z₅) of the index mark ID with respect to the vision sensor 14 at this time. In step S25, the processor 50 acquires a trial measurement position of the vision sensor 14. Specifically, the processor 50 calculates a vector (ΔX₁. ΔY₁, ΔZ₁) from the origin of the reference coordinate system C4 in the MIF coordinate system C2 to the origin of the sensor coordinate system C3, which is unknown, by using the relative position data (X₀, Y₀, Z₀), (X₄, Y₄, Z₄) and (X₅, Y₅, Z₅), and Equations (4) and (5) described above.

Subsequently, the processor 50 acquires, from the vector (ΔX₁, ΔY₁, ΔZ₁), the position of the vision sensor 14 (the origin of the sensor coordinate system C3) as coordinates of the MIF coordinate system C2 (x_{T}, y_{T}, z_{T}), and acquires coordinates (x_{T}′, y_{T}′, z_{T}′) obtained by converting the coordinates of the MIF coordinate system C2 (x_{T}, y_{T}, z_{T}) to the robot coordinate system C1, as the trial measurement position of the vision sensor 14 in the robot coordinate system C1. The trial measurement position (x_{T}′, y_{T}′, Z_{T}′) indicates an approximate position of the vision sensor 14 in the robot coordinate system C1.

Referring to FIG. 8, in step S31, the processor 50 rotationally moves the index mark ID, thereby changing the orientation of the index mark ID. Specifically, the processor 50 defines a direction DR₁ (orientation change direction), in which the index mark ID is moved in order to change the orientation of the index mark ID in step S31, as a direction about the z-axis of the sensor coordinate system C3, the origin position of which has been updated in step S25.

The origin position of the sensor coordinate system C3 in the robot coordinate system C1 at this time point is the trial measurement position (x_{T}′, y_{T}′, z_{T}′), and therefore the z-axis of the sensor coordinate system C3 is an axis arranged at the trial measurement position (x_{T}′, y_{T}′, z_{T}′) and parallel to the direction of the visual line O. In this way, the processor 50 defines the orientation change direction DR₁ based on the trial measurement position (X_{T}′, Y_{T}′, Z_{T}′). Subsequently, the processor 50 operates the robot 12 to rotate the index mark ID by an orientation change amount θ₃ (second orientation change amount) in the orientation change direction DR₁ (the direction about the z-axis of the sensor coordinate system C3) from the initial position PS₀ and initial orientation OR₀.

In step S32, the processor 50 operates the vision sensor 14 to image an image of the index mark ID and acquire relative position data (X₆, Y₆, Z₆) of the index mark ID with respect to the vision sensor 14 at this time. In step S33, the processor 50 rotationally moves the index mark ID, thereby changing the orientation of the index mark ID.

Specifically, the processor 50 first defines a direction DR₂ (orientation change direction), in which the index mark ID is moved in order to change the orientation of the index mark ID in step S33, as a direction about the x-axis or y-axis of the sensor coordinate system C3, the origin position of which has been updated in step S25. The origin position of the sensor coordinate system C3 in the robot coordinate system C1 at this time point is the trial measurement position (X_{T}′, y_{T}′, Z_{T}′), and therefore the x-axis or y-axis of the sensor coordinate system C3 is an axis arranged at the trial measurement position (x_{T}′, y_{T}′, z_{T}′) and orthogonal to the direction of the visual line O.

In this way, the processor 50 defines the orientation change direction DR₂ based on the trial measurement position (x_{T}′, y_{T}′, z_{T}′). Subsequently, the processor 50 operates the robot 12 to rotate the index mark ID by an orientation change amount θ₄ (second orientation change amount) in the orientation change direction DR₂ (the direction about the x-axis or y-axis of the sensor coordinate system C3) from the initial position PS₀ and initial orientation OR₀.

In step S34, the processor 50 operates the vision sensor 14 to image an image of the index mark ID and acquire relative position data (X₇, Y₇, Z₇) of the index mark ID with respect to the vision sensor 14 at this time. In step S35, the processor 50 acquires a real measurement position of the vision sensor 14.

Specifically, the processor 50 calculates a vector (ΔX₂, ΔY₂, ΔZ₂) from the trial measurement position (x_{T}′, y_{T}′, z_{T}′) in the robot coordinate system C1 having been determined in step S25 to the exact origin of the sensor coordinate system C3, by using the relative position data (X₀, Y₀, Z₀), (X₆, Y₆, Z₆) and (X₇, Y₇, Z₇), and Equations (6) and (7) described above. Then, the processor 50 acquires the position of the vision sensor 14 (the origin of the sensor coordinate system C3) from the vector (ΔX₂, ΔY₂, ΔZ₂) in the robot coordinate system C1, as the real measurement position (x_{R}′, y_{R}′, Z_{R}′).

As described above, in the robot system 10′, the processor 50 acquires the trial measurement position (x_{T}′, y_{T}′, z_{T}′) and the real measurement position (x_{R}′, y_{R}′, z_{R}′). According to the present embodiment, similar to the aforementioned embodiment, the index mark ID can be prevented from being out of the field of view of the vision sensor 14 in steps S21, S23, S31, and S33.

In the flow depicted in FIG. 8, the processor 50 may determine, after step S32, a vector (ΔX₂. ΔY₂) by using the relative position data (X₀, Y₀, Z₀) and (X, Y₆, Z₆), and Equation (6) discussed above, and may acquire a real measurement position (x_{R}, y_{R}) of the visual line O of the MIF coordinate system C2 in the MIF coordinate system C2 from the vector (ΔX₂, ΔY₂). Then, the processor 50 updates the trial measurement position (X_{T}, y_{T}, z_{T}) to a trial measurement position (x_{R}, y_{R}, z_{T}) with the real measurement position (x_{R}, y_{R}) of the visual line O.

Subsequently, in step S33 in FIG. 8, the processor 50 defines an orientation reference position RP by using the trial measurement position (x_{R}, y_{R}, z_{T}) obtained by the update and the relative position data (X₀, Y₀, Z₀) acquired in step S12. Specifically, in the MIF coordinate system C2 of the initial position PS₀ and the initial orientation OR₀, the processor 50 defines the orientation reference position RP at a position separated from the trial measurement position (x_{R}, y_{R}, z_{T}) after the update by the vector (X₀, Y₀, Z₀) (i.e., at a position of the coordinates (x_{R}+X₀, y_{R}+Y₀, z_{T}+Z₀) of the MIF coordinate system C2).

According to this configuration, of the trial measurement position (x_{R}, y_{R}, z_{T}) after the update, the coordinates (x_{R}, y_{R}) indicate an exact position of the visual line O in the MIF coordinate system, and therefore the orientation reference position RP can more accurately be set at the intersection point F of the index mark ID. As a result, the index mark ID can more effectively be prevented from being out of the field of view of the vision sensor 14 in step S33.

In the above-described embodiments, the cases in which steps S21. S23, S31, and S33 are executed with the initial position PS₀ and the initial orientation OR₀ taken as a starting point are described, but the present disclosure is not limited thereto; the vision sensor 14 may be arranged in a second initial position PS_{0_2} and a second orientation OR_{0_2} different from the initial position PS₀ and the initial orientation OR₀ to image an image of the index mark ID at the starting time of step S3 or S4, and relative position data (X_{0_2}, Y_{0_2}, Z_{0_2}) may be acquired based on the image data. In this case, the processor 50 acquires a trial measurement position or a real measurement position based on the relative position data (X_{0_2}. Y_{0_2}. Z_{0_2}) in step S25 or S35.

In the above-described embodiments, the case in which the processor 50 acquires a position of the vision sensor 14 in the control coordinate system based on the relative position (Xₙ, Yₙ, Zₙ) is described. However, the concept of the present invention is also applicable to an embodiment in which the position of the vision sensor 14 in the control coordinate system is acquired by methods as described in PTL 1 and PTL 2, for example.

Hereinafter, another method for acquiring the position of the vision sensor 14 will be described. First, the processor 50 images an image of an index mark ID by the vision sensor 14 while moving the vision sensor 14 or the index mark ID by the robot 12, and performs a positioning process PP, in which the position (the coordinates of the sensor coordinate system C3) of the index mark ID (intersection point F) in the imaged image data JDₙ is positioned at a predetermined position (e.g., the center of the image). Then, the processor 50 acquires coordinates CD₁ (initial position) of the origin of the MIF coordinate system C2 in the robot coordinate system C1 at the time point when the positioning process PP is completed.

Subsequently, the processor 50 makes the vision sensor 14 or the index mark ID perform translation movement from the initial position, then images an image of the index mark ID again by the vision sensor 14 and performs the above-described positioning process PP, and acquires coordinates CD₂ of the origin of the MIF coordinate system C2 in the robot coordinate system C1 at this time. The processor 50 acquires a direction of the visual line O (i.e., an orientation) of the vision sensor 14 in the robot coordinate system C1 from the coordinates CD₁ and CD₂.

Subsequently, as a trial measurement process, the processor 50 rotates the vision sensor 14 or the index mark ID from the initial position in a direction about an axis parallel to the acquired direction of the visual line O by an orientation change amount θ₁, then images an image of the index mark ID by the vision sensor 14, and performs the above-described positioning process PP. Then, the processor 50 acquires coordinates CD₃ of the origin of the MIF coordinate system C2 in the robot coordinate system C1 at this time. Then, the processor 50 determines a position TP₁ of the visual line O in the robot coordinate system C1 from the coordinates CD₁ and CD₃.

Subsequently, as the trial measurement process, the processor 50 makes the vision sensor 14 or the index mark ID rotate from the initial position in a direction about an axis orthogonal to the visual line O arranged in the position TP₁ by an orientation change amount θ₂, then images an image of the index mark ID by the vision sensor 14 and performs the above-described positioning process PP, and acquires coordinates CD₄ of the origin of the MIF coordinate system C2 in the robot coordinate system C1 at this time.

The processor 50 determines a position TP₂ in a direction along the visual line O of the vision sensor 14 (the origin of the sensor coordinate system C3) in the robot coordinate system C1 from the coordinates CD₁ and CD₄. From the positions TP₁ and TP₂, a trial measurement position (X_{T}′, Y_{T}′, Z_{T}′) of the vision sensor 14 (the origin of the sensor coordinate system C3) in the robot coordinate system C1 may be acquired.

Subsequently, as a real measurement process, the processor 50 defines the orientation change direction as a direction about the axis parallel to the direction of the visual line O arranged in the trial measurement position (x_{T}′, y_{T}′, z_{T}′), rotates the vision sensor 14 or the index mark ID in the orientation change direction from the initial position by an orientation change amount θ₃ (>θ₁), then images an image of the index mark ID by the vision sensor 14, and performs the above-described positioning process PP. The processor 50 acquires coordinates CD₅ of the origin of the MIF coordinate system C2 in the robot coordinate system C1 at this time, and determines a position TP₃ of the visual line O in the robot coordinate system C1 from the coordinates CD₁ and CD₅.

Subsequently, as the real measurement process, the processor 50 defines the orientation change direction as a direction about the axis orthogonal to the visual line O arranged in the trial measurement position (x_{T}′, y_{T}′, z_{T}′), rotates the vision sensor 14 or the index mark ID in the orientation change direction from the initial position by an orientation change amount θ₄ (>θ₂), and then performs the above-described positioning process PP. Then, the processor 50 acquires coordinates CD₆ of the origin of the MIF coordinate system C2 in the robot coordinate system C1 at this time.

Subsequently, the processor 50 determines a position TP₄ in a direction along the visual line O of the vision sensor 14 (the origin of the sensor coordinate system C3) in the robot coordinate system C1 from the coordinates CD₁ and CD₆. From the positions TP₃ and TP₄, a real measurement position (x_{R}′, y_{R}′, z_{R}′) of the vision sensor 14 (the origin of the sensor coordinate system C3) in the robot coordinate system C1 may be acquired.

In this method as well, the processor 50 acquires the position of the vision sensor 14 in the control coordinate system based on the image data of the index mark ID imaged by the vision sensor 14 before the change of the orientation (the image data imaged in the positioning process PP for determining the initial position) and the image data of the index mark ID imaged by the vision sensor 14 after the change of the orientation (the image data imaged in the positioning process PP for determining the coordinates CD₃, CD₄, and CD₅). By this method as well, the processor 50 may acquire the position (the trial measurement position, the real measurement position) of the vision sensor 14 in the control coordinate system.

In the above-described embodiments, the case in which the teaching device 18 acquires the data on the position and orientation of the vision sensor 14 in the control coordinate system is described. However, the control device 16 may acquire the data on the position and orientation of the vision sensor 14 in the control coordinate system. In this case, the processor 40 of the control device 16 carries out the flow depicted in FIG. 4 in accordance with the computer program CP.

Alternatively, a device separated from the teaching device 18 and the control device 16 may acquire the data on the position and orientation of the vision sensor 14 in the control coordinate system. In this case, the separated device is provided with a processor, and the processor carries out the flow depicted in FIG. 4 in accordance with the computer program CP.

The index mark ID is not limited to an artificial pattern as described in the above-described embodiments; for example, any visual feature that is visually recognizable, such as a hole, edge, engraving, or pointed end formed in the holding structure B or wrist flange 34, may be used as the index mark. Further, the robot 12 is not limited to a vertical articulated robot, and any type of robot capable of relatively moving the vision sensor 14 and the index mark ID, such as a horizontal articulated robot or a parallel link robot, may be employed. Although the present disclosure is described above through the embodiments, the above-described embodiments do not limit the invention according to the claims.

### REFERENCE SIGNS LIST

10, 10′ Robot system
12 Robot
14 Vision sensor
16 Control device
18 Teaching device

1. A device configured to acquire a position of a vision sensor in a control coordinate system for controlling a robot configured to relatively move the vision sensor and an index mark, the device comprising a processor configured to:
operate the robot so as to change an orientation of the vision sensor or the index mark by a first orientation change amount;
acquire, as a trial measurement position, a position of the vision sensor in the control coordinate system, based on image data of the index mark imaged by the vision sensor before and after the orientation is changed by the first orientation change amount;
operate the robot so as to change the orientation by a second orientation change amount larger than the first orientation change amount in an orientation change direction which is determined based on the trial measurement position; and
acquire, as a real measurement position, a position of the vision sensor in the control coordinate system, based on image data of the index mark imaged by the vision sensor before and after the orientation is changed by the second orientation change amount.

2. The device of claim 1, wherein the processor is configured to:
acquire a direction of a visual line of the vision sensor in the control coordinate system in advance;
operate the robot so as to rotate the vision sensor or the index mark in a direction about an axis parallel to the direction of the visual line in order to change the orientation by the first orientation change amount;
determine the direction about the axis arranged at the trial measurement position, as the orientation change direction;
operate the robot so as to rotate the vision sensor or the index mark in the orientation change direction in order to change the orientation by the second orientation change amount; and
acquire a position of the visual line in the control coordinate system as the trial measurement position and the real measurement position.

3. The device of claim 1, wherein the processor is configured to:
acquire a direction of a visual line of the vision sensor in the control coordinate system in advance;
operate the robot so as to rotate the vision sensor or the index mark in a direction about an axis orthogonal to the direction of the visual line in order to change the orientation by the first orientation change amount;
determine the direction about the axis arranged at an orientation reference position which is determined based on the trial measurement position, as the orientation change direction;
operate the robot so as to rotate the vision sensor or the index mark in the orientation change direction in order to change the orientation by the second orientation change amount; and
acquire the position of the vision sensor in the direction of the visual line in the control coordinate system, as the trial measurement position and the real measurement position.

4. The device of claim 3, wherein the processor is configured to:
acquire, based on the image data imaged by the vision sensor before changing the orientation by the second orientation change amount, a relative position of the index mark with respect to the vision sensor when the vision sensor images the image data; and
determine the orientation reference position with reference to the trial measurement position such that the acquired relative position and a relative position of the orientation reference position with respect to the trial measurement position are identical.

5. The device of claim 1, wherein the vision sensor includes an image sensor configured to receive a subject image, and an optical lens configured to focus the subject image onto the image sensor,
wherein the processor is configured to:
acquire a relative position of the index mark with respect to the vision sensor when the vision sensor images the image data, based on a position of the index mark in the image data, a size of the index mark shown in the image data, a size of the index mark in a real space, a focal distance of the optical lens, and a size of the image sensor;
acquire the trial measurement position based on the first orientation change amount, the relative position when the image data is imaged before changing the orientation by the first orientation change amount, and the relative position when the image data is imaged after changing the orientation by the first orientation change amount; and
acquire the real measurement position based on the second orientation change amount, the relative position when the image data is imaged before changing the orientation by the second orientation change amount, and the relative position when the image data is imaged after changing the orientation by the second orientation change amount.

6. The device of claim 1, wherein the device is a teaching device or a control device of the robot.

7. A robot system comprising:
a vision sensor;
a robot configured to relatively move the vision sensor and an index mark; and
the device of claim 1.

8. A method of acquiring a position of a vision sensor in a control coordinate system for controlling a robot configured to relatively move the vision sensor and an index mark, the method comprising, by a processor:
operating the robot so as to change an orientation of the vision sensor or the index mark by a first orientation change amount;
acquiring, as a trial measurement position, a position of the vision sensor in the control coordinate system based on image data of the index mark imaged by the vision sensor before and after the orientation is changed by the first orientation change amount;
operating the robot so as to change the orientation by a second orientation change amount larger than the first orientation change amount in an orientation change direction which is determined based on the trial measurement position; and
acquiring, as a real measurement position, a position of the vision sensor in the control coordinate system based on image data of the index mark imaged by the vision sensor before and after the orientation is changed by the second orientation change amount.

9. A computer-readable storage medium configured to storage a computer program configured to cause a processor to execute the method of claim 8.
